(19) United States
(12) Patent Application Publication
(10) Pub. No.: US 2006/0102753 A1
(43) Pub. Date: May 18, 2006

(54) Fuel injection nozzle and method for manufacturing the same

(75) Inventor: Akio Tanaka, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/274,265

(22) Filed: Nov. 16, 2005

(30) Foreign Application Priority Data
Nov. 17, 2004 (JP) 2004-332925
Oct. 17, 2005 (JP) 2005-302109

(51) Int. Cl. F02M 63/00

(52) U.S. Cl. 239/533.2

(57) ABSTRACT

When the body of the injector nozzle is manufactured, the body is tempered at a predetermined temperature which is higher than a receiving-heat-temperature. A temperature of the body is increased up to the receiving-heat-temperature, receiving a heat from a combustion chamber of an internal combustion engine during the engine is running. The body is hardly softened due to tempering during its operation. When the seat sits on the seat face, the seat tends to be abrasive wore.

### CROSS REFERENCE TO RELATED APPLICATIONS

This application is based on Japanese Patent Applications No. 2004-332925 filed on Nov. 17, 2004 and No. 2005-302109 filed on Oct. 17, 2005, the disclosure of which are incorporated herein by reference.

### FIELD OF THE INVENTION

The present invention relates to a fuel injection nozzle and method for manufacturing the fuel injection.

### BACKGROUND OF THE INVENTION

As shown in FIGS. 7A and 7B, a fuel injection nozzle 100 includes a body 102 and a needle 103. The body 102 is provided with a plurality of injection holes 101 which are opened/closed by the needle 103. When the needle 103 is lifted, the injection holes 101 are opened to inject fuel into a combustion chamber of an engine. When a seat 104 of the needle 103 is seated on a seat face 105, the injection holes 101 are closed to stop injecting the fuel.

Generally, the body 102 is made of case-hardened steel for machine structural use, which is tempered. In a case that the fuel injection nozzle is mounted on a direct-injection-type engine, such as a diesel engine, the fuel injection nozzle 100 directly receives a combustion heat in the combustion chamber, so that temperature of the fuel injection nozzle 100 is increased to a specific temperature which depends on an engine running condition. This specific temperature is referred to as a receiving-heat-temperature, hereinafter.

In the situation that the receiving-heat-temperature is higher than a tempering temperature, the seat face 105 of the body 102 may be worn away by the seat 104, so that a sealing line is moved from the seat 104 to another seat 104a as shown in FIG. 7C. A pressure receiving area of the needle 103 to which fuel pressure is applied in opening direction of the injection holes is reduced, so that fuel injection timing may be retarded to decrease the fuel injection amount.

In the situation that the receiving-heat-temperature is lower than the tempering temperature, the seat 104 may be worn away by the seat face 105, so that the sealing line is moved from the seat 104 to the other seat 104b of which diameter is smaller than that of the seat 104 as shown in FIG. 7D. The pressure receiving area of the needle 103 may be increased so that the fuel injection timing is advanced to increase the fuel injection amount.

In the case that the body 102 is made of case-hardened steel for machine structural use, a direction of variation in fuel injection amount is quite opposite according to whether the receiving-heat-temperature is higher than the tempering temperature or not, as shown in FIG. 8. Thus, a correction of fuel injection amount due to abrasive wear is hardly conducted in a uniform way.

Besides, a requirement of increment in fuel injection pressure causes an increment in force which biasing the seat 104 toward the seat face 105. A possibility of abrasive wear of the seat 104 and the seat face 105 increases.

U.S. Pat. No. 4,801,095 and JP-2004-3435A show technique to harden the seat face 105. According to the technique shown in U.S. Pat. No. 4,801,095, the seat surface 105 is carburized to improve hardness thereof. According the technique shown in JP-2004-3435A, the seat surface 105 is carburized and nitrided.

Although these techniques improve the hardness of the seat 105 at a time of producing thereof, the problem of aging abrasive wear is still remained.

It is possible to use high-speed steel instead of the case-hardened steel. However, it causes high material cost.

### SUMMARY OF THE INVENTION

The present invention is made in view of the foregoing matter and it is an object of the present invention to provide a fuel injection nozzle in which the direction of the abrasive wear is unified to uniformly conduct a correction of the fuel injection amount due to the aging.

According to the present invention, a fuel injection nozzle comprising a body provided with a fuel injection hole, and a valve accommodated in the body to open/close the fuel injection hole. The fuel injection nozzle injects fuel into a combustion chamber of an internal combustion engine. The body receives heat from the combustion chamber so that a temperature of the body is increased up to a receiving-heat-temperature. The body is tempered at a predetermined temperature which is higher than the receiving-heat-temperature.

### BRIEF DESCRIPTION OF THE DRAWINGS

The above and other objects, features, and advantages of the present invention will become more apparent from the following detailed description made with reference to the accompanying drawings, in which like parts are designated by like reference number and in which:

FIG. 1 is a cross sectional view of a nozzle according to a first embodiment of the present invention;

FIG. 2 is a graph showing a relationship between a specific power and a receiving-heat-temperature of a body;

FIG. 3A is a cross sectional view of essential part of the nozzle, FIG. 3B is an enlarged view showing a contact condition between a needle and a body;

FIG. 4 is a graph showing a variation of a fuel injection amount;

FIG. 5 is a graph showing a relationship between a surface content rate of nitrogen and a reduction of hardness;

FIG. 6 is a graph showing a relationship between a content rate of silicon and a reduction of hardness according to a second embodiment;

FIG. 7A is a cross sectional view of essential part of the nozzle, FIG. 7B is an enlarged view showing a contact condition between the needle and the body before an abrasive wear, FIG. 7C is an enlarged view showing a contact condition between the needle and the body in a case that the receiving-heat-temperature is higher than the tempering temperature, FIG. 7D is an enlarged view showing a conventional contact condition between the needle and the body in a case that the receiving-heat-temperature is lower than the tempering temperature; and

FIG. 8 is a graph showing a conventional aging of fuel injection amount.

### DETAILED DESCRIPTION OF THE PREFERRED EMBODIMENTS

Embodiments of the present invention will be described hereinafter with reference to the drawings.

### First Embodiment

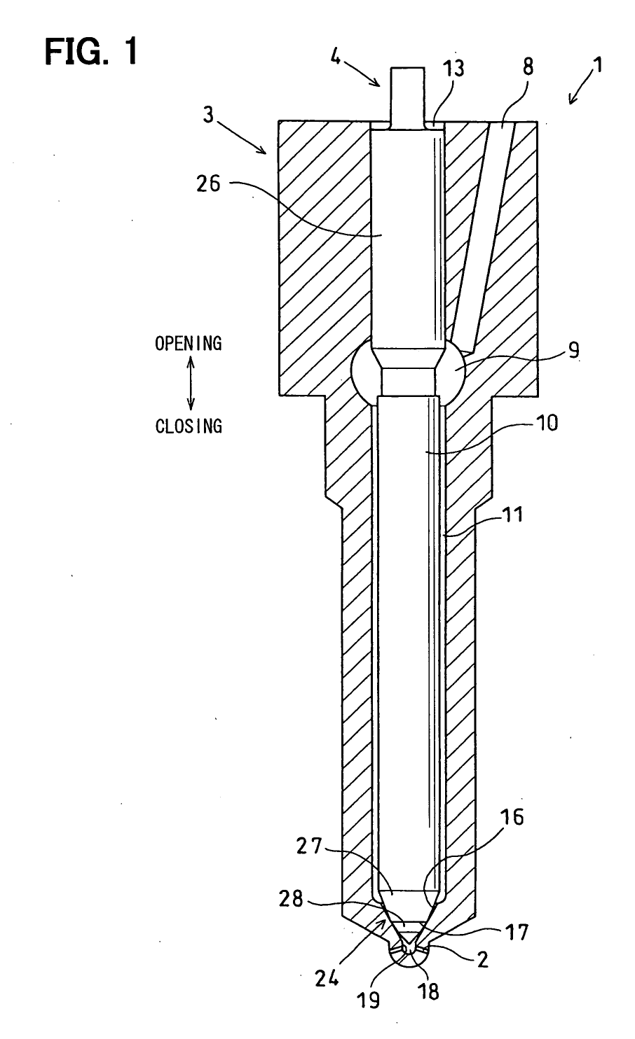

Referring to FIG. 1, a structure of a fuel injection nozzle 1, which is referred to as a nozzle 1 hereinafter, will be described.

The nozzle 1 includes a body 3 having a plurality of injection holes 2 and a needle 4 slidabily accommodated in the body 3. The needle 4 functions as a valve which opens/closes the injection holes 2. The nozzle 1 is held by a nozzle holder (not shown). The nozzle 1 and an electromagnetic valve (not shown) comprise a fuel injection valve. An electronic control unit (ECU: not shown) operates the electromagnetic valve.

The fuel injection valve for injecting fuel into a combustion chamber is mounted on a direct-injection-type engine, such as a multi-cylinder diesel engine, which is referred to as an engine hereinafter. The body 3 directly receives a combustion heat in the combustion chamber. A temperature of the body 3 is increased to the receiving-heat-temperature which depends on the engine running condition.

The fuel is pressurized by a well-known injection pump and injected into the combustion chamber of the engine through a well-known common rail (not shown).

The body 3 is provided with a fuel passage 8, a fuel chamber 9 for receiving the fuel form the common rail through the fuel passage 8, a guide bore 11 accommodating a needle body 10, and a sliding bore 13 slidablly accommodating the needle body 10 in an axial direction thereof.

A seat face 16 having a conical surface is formed at bottom end portion of the guide bore 11. The inner diameter for the seat face 16 increases according as it is closes to the bottom end. A seat 17 of the needle 4 can seat on the seat face 16 and can be apart from the seat 16. A sac chamber 18 is provided at tip end of the seat 16. An inner surface 19 of the sac chamber 18 is provided with a plurality of injection holes 2. When the seat 17 is apart from the seat face 16, the injection holes 16 are opened to inject the fuel, and when the seat 17 seats on the seat surface 16, the injection holes 16 are closed to stop the fuel injection.

The needle 4 includes a column-shaped needle body 10 and a tip portion 24. A back end portion of the needle body 19 forms a sliding axial portion 26 which is slidablly accommodated in the sliding bore 13. The tip portion 24 comprises a first conical face 27 and a second conical face 28. A ridgeline between the first conical face 27 and the second conical face 28 functions as the seat 17.

The feature of the nozzle 1 is described hereinafter.

A method for producing the needle 1 includes a tempering step. The nozzle 1 can be used for a diesel engine of a passenger car or a diesel engine of a truck.

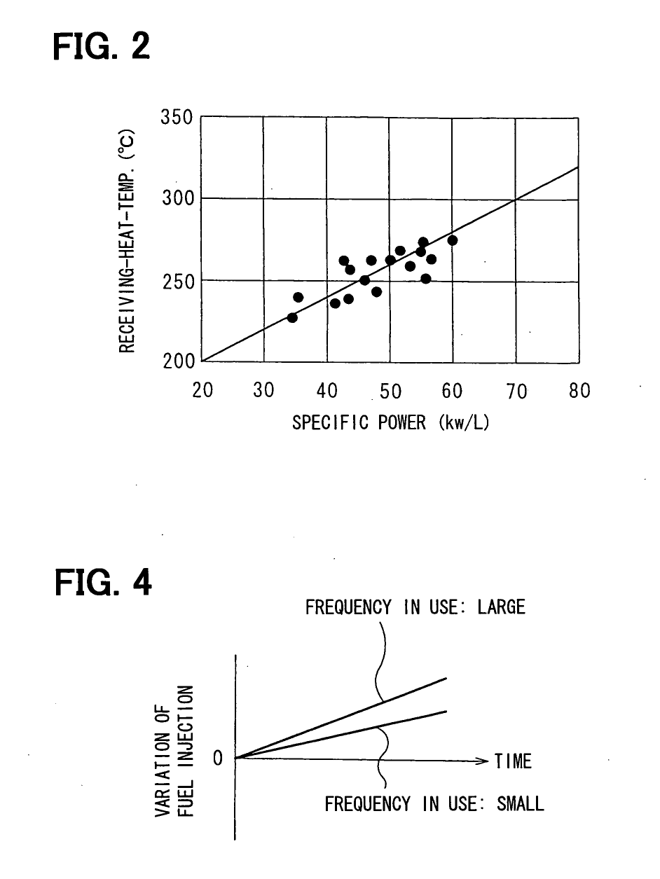

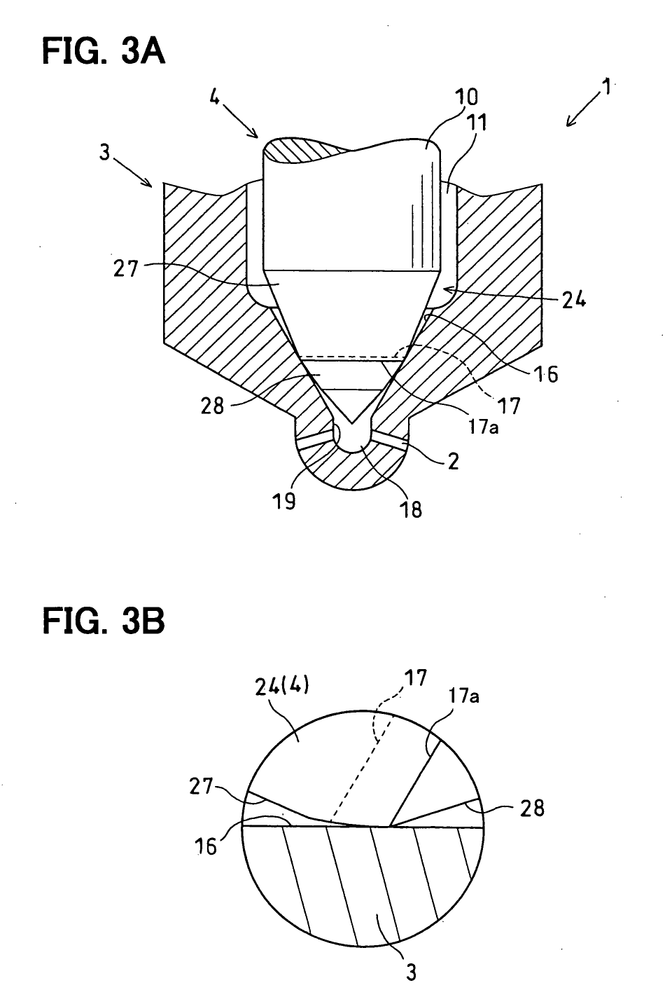

In the tempering step, the temperature of the tempering is set according to an engine of which combustion temperature is highest. That is, the tempering temperature is higher than the receiving-heat-temperature. For example, in the case that the receiving-heat temperature is 220-270° C. as shown in FIG. 2, the tempering is conducted at 270 or higher. The tempering temperature can be 270° C., 280° C., 290° C., or 300° C.

The fuel is pressurized by an injection pump and is supplied to the nozzle through the common rail. The injection pressure of the fuel is higher than at least 150 MPa.

The body 3 is made of case-hardened steel for machine structure use. A surface content rate of carbon and nitrogen at the seat face 16 is higher than an internal content rate of carbon and nitrogen. The surface content rate means a content rate from the surface of the seat face 16 to a portion having a depth of 0.05 mm. The surface content rate of carbon is 0.6 wt %-1.0 wt %, and that of nitrogen is 0.4 wt %-0.9 wt %.

Referring to FIG. 1, the operation of the nozzle 1 is described hereinafter.

When the electromagnetic valve is energized receiving a signal from the ECU, a biasing force biasing the needle 4 in an injection-holes-closing direction is decreased, and a fuel pressure in the fuel chamber 9 and a fuel pressure between the seat face 16 and the first conical face 27 causes a movement of the needle 4 in the injection-holes-opening direction. The seat 17 is moved away from the seat 16 so that the pressurized fuel is injected into the combustion chamber through the injection holes 2.

When the electromagnetic valve is deenergized, the biasing force biasing the needle 4 in the injection-holes-closing direction is increased. When the biasing force in the injection-holes-closing direction is greater than the force in the injection-holes-opening direction, the needle 4 is moved in the injection-holes-closing direction. The seat 17 seats on the seat surface 16 to interrupt a communication between the injection holes 2 and the guide bore 11 so that the fuel injection is stopped.

Effect of the First Embodiment

The body 3 of the nozzle 1 is tempered at the specified temperature which is higher than the receiving-heat-temperature, whereby, the body 3 is not used under the condition in which the ambient temperature is higher than the tempered temperature so that the body 3 is not tempered in its use. Thus, the body 3 is hardly softened, the direction of abrasive wear is unified in to the direction in which the seat 17 of the needle 4 is worn relative to the seat face 16.

As the result, the seat 17 is moved to the seat 17a after wearing of which diameter is smaller than that of the seat 17. Because the pressure receiving area of the tip portion 24 is increased, a timing in which the seat 17a is moved away from the seat face 16 is earlier than a timing in which the seat 17 is moved away from the face 16. Thus, as shown in FIG. 4, the injection timing is advanced to increase a fuel injection amount with ageing. The correction of the fuel injection amount is conducted with respect to the increment of fuel injection amount without considering the decrement of the fuel injection amount.

According to the nozzle 1 of the first embodiment, the direction of the abrasive wear between the seat face 16 and the seat 17 can be unified to uniformly conduct the correction of the fuel injection amount due to the ageing. The pressurized fuel having a pressure of more than 150 MPa is injected through the nozzle 1. Even under the condition in which the abrasive wear of the seat face 16 and seat 17 is increasing, the direction of the abrasive wear is unified to uniformly conduct the correction of the fuel injection amount due to the aging.

In this first embodiment, the tempering temperature of the body 3 is at least 270° C. The receiving-heat-temperature of the body 3 in the modern engine is approximately 220° C. to 270° C. In the case that the body 3 is tempered at 270° C., the body 3 is hardly softened due to the tempering without respect to the engine on which the nozzle 1 is mounted.

The nozzle 1 according to the first embodiment has compatibility between different types of engines. In the case that the tempering temperature of the body 3 is established based on the engine of which the receiving-heat-temperature is highest, the body 3 is hardly softened even when the nozzle is mounted on any types of engines. Even when the nozzle 1 has the compatibility between the engines, the direction of the abrasive wear is unified. Thus, it is needless to change the tempering temperature according to the engine on which the nozzle 1 mounted.

The body 3 of the nozzle 1 is made of the case-hardened steel for machine structure use, and the surface content rate of the carbon and nitrogen is higher than the internal content rate of that. When the content rate of carbon and nitrogen is increased, reduction of hardness of the body 3 is restricted even when the tempering is conducted at a temperature which is higher than the receiving-heat-temperature. Thus, increment of the surface content rate of carbon and nitrogen results in a reduction of abrasive wears of the seat face 16.

As described above, by controlling the surface content rate of carbon and nitrogen, the reduction of hardness of the seat face 16 at tempering is restricted, and a tenacity of the seat face 16 is maintained high.

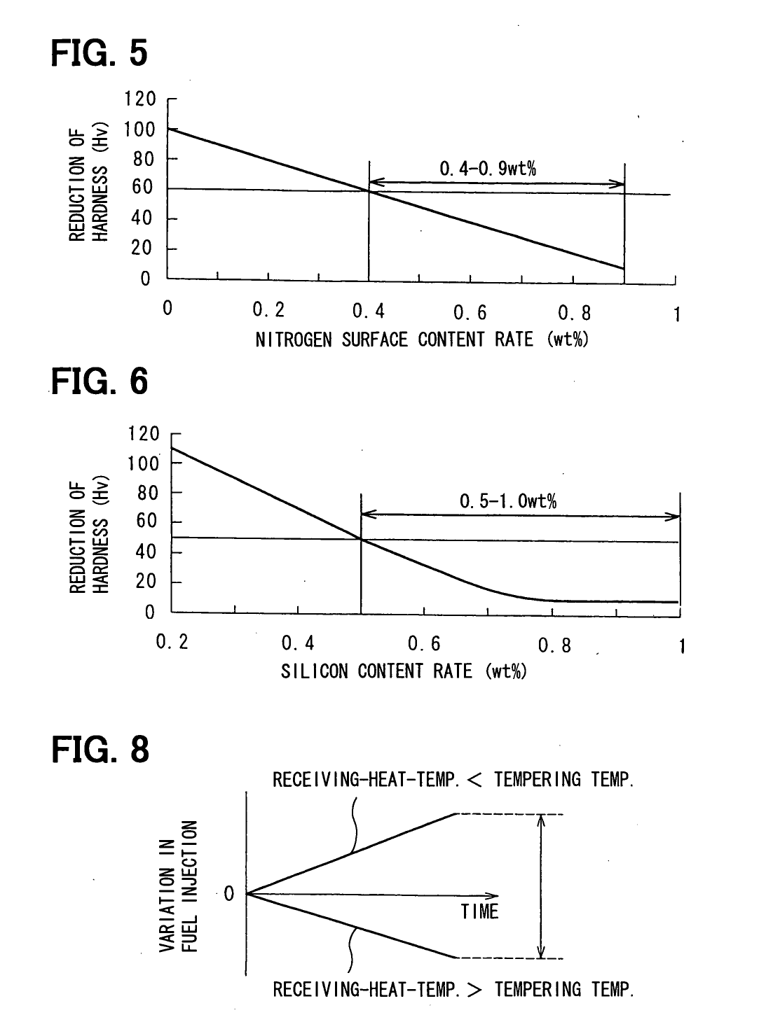

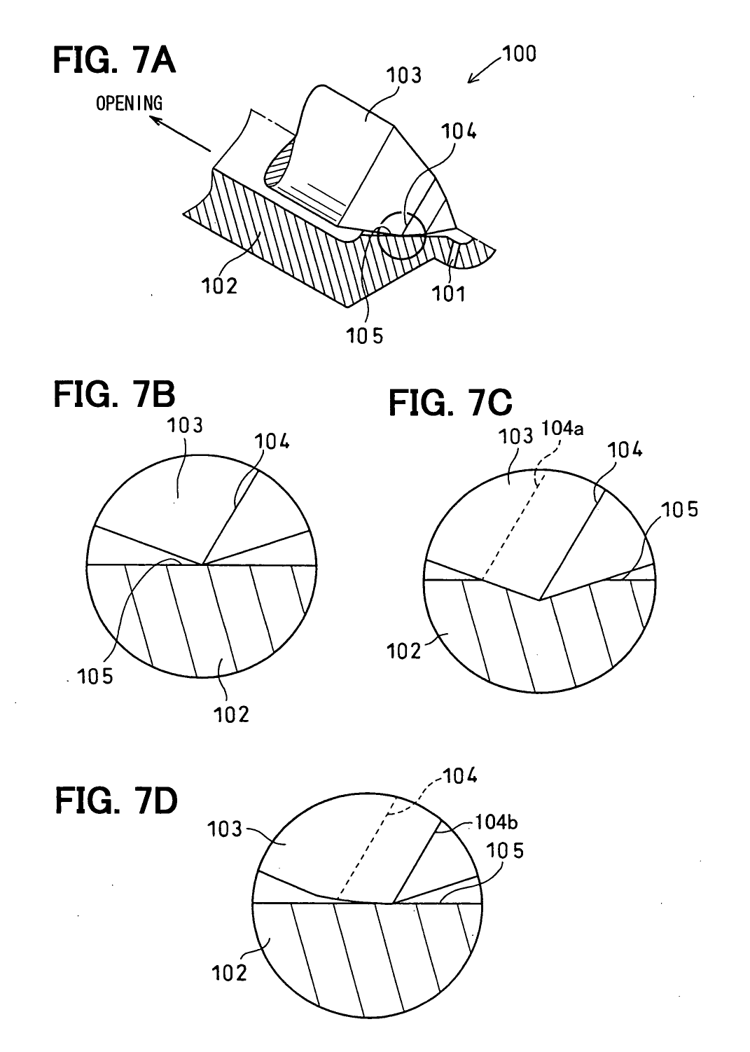

FIG. 5 shows a relationship between the surface content rate of nitrogen and the reduction of hardness. The reduction of hardness represents a decrement in Vickers hardness in the case of tempering at 300° C. According to the graph shown in FIG. 5, when the surface content rate of nitrogen is 0.4 wt % to 0.9 wt %, the reduction of hardness is restricted under 60.

### Second Embodiment

According to a second embodiment, the body 3 of the nozzle 1 is made of chrome molybdenum steel in which silicon is added, whereby the mechanical strength of the body 3 is increased to reduce the abrasive wear of the seat face 16.

The content rate of silicon in the chrome molybdenum steel is 0.5 wt % to 1.0 wt %. By controlling the content rate of silicon, the reduction of hardness at the time of tempering can be restricted.

FIG. 6 shows a relationship between the content rate of silicon and the reduction of hardness. When the content rate of silicon is 0.5 wt % to 1.0 wt %, the reduction of hardness can be restricted under 50.

What is claimed is:

1. A method for producing a fuel injection nozzle that includes a body provided with a fuel injection hole and a valve accommodated in the body to open/close the fuel injection hole, the fuel injection nozzle injecting fuel into a combustion chamber of an internal combustion engine, the body receiving heat from the combustion chamber so that a temperature of the body is increased up to a receiving-heat-temperature, the method comprising:
a tempering step in which the body is tempered at a predetermined temperature which is higher than the receiving-heat-temperature.

2. A fuel injection nozzle comprising:
a body provided with a fuel injection hole; and
a valve accommodated in the body to open/close the fuel injection hole, wherein
the fuel injection nozzle injects fuel into a combustion chamber of an internal combustion engine,
the body receives heat from the combustion chamber so that a, temperature of the body is increased up to a receiving-heat-temperature,
the body is tempered at a predetermined temperature which is higher than the receiving-heat-temperature, and
the fuel is pressurized more than 150 MPa to be injected into the combustion chamber.

3. A fuel injection nozzle comprising:
a body provided with a fuel injection hole; and
a valve accommodated in the body to open/close the fuel injection hole, wherein
the fuel injection nozzle injects fuel into a combustion chamber of an internal combustion engine,
the body receives heat from the combustion chamber so that a temperature of the body is increased up to a receiving-heat-temperature,
the body is tempered at a predetermined temperature which is higher than the receiving-heat-temperature, and
a tempering temperature is more than 270° C.

4. A fuel injection nozzle according to claim 2, wherein
the fuel injection nozzle can be mounted on any types of internal combustion engine.

5. The fuel injection nozzle according to claim 2, wherein
the body is made of case-hardened steel for machine structure use, and
a carbon and nitrogen surface content rate of a seat face on which the valve seats is greater that a carbon and nitrogen interior content rate.

6. The fuel injection nozzle according to claim 5, wherein
the surface content rate represents a content rate from a surface of the seat face to a portion having a depth of 0.05 mm,
a carbon surface content rate is 0.6 wt % to 1.0 wt %, and
a nitrogen surface content rate is 0.4 wt % to 0.9 wt %.

7. The fuel injection nozzle according to claim 5, wherein
the case-hardened steel for machine structure use is chrome molybdenum steel in which silicon is added.

8. The fuel injection nozzle according to claim 7, wherein
silicon content rate of the chrome molybdenum steel is 0.5 wt % to 1.0 wt %.
